(19) United States
(12) Patent Application Publication
(10) Pub. No.: US 2024/0254813 A1
(43) Pub. Date: Aug. 1, 2024

(54) HOOD SYSTEM WITHOUT POP-UP SPRING

(71) Applicant: MAGNA CLOSURES INC., Newmarket (CA)

(72) Inventors: Ryan HERMAN, Aurora (CA); Francesco CUMBO, Pisa (IT)

(21) Appl. No.: 18/426,954

(22) Filed: Jan. 30, 2024

Related U.S. Application Data
(60) Provisional application No. 63/482,665, filed on Feb. 1, 2023.

(51) Int. Cl. E05B 81/20; E05B 83/24

(52) U.S. Cl. CPC E05B 81/20; E05B 83/24

(57) ABSTRACT

A closure panel movement system for moving a closure panel of a frunk of a vehicle between a fully closed position and a fully open position, the system comprising: a latch mounted to a body of the vehicle, the latch for maintaining the closure panel in the fully closed position; a presentment mechanism positioned between the closure panel and the body; and a drive unit coupled to the closure panel for driving the closure panel when unlatched to and from the fully open position; wherein the presentment mechanism assists in movement of the closure panel between a pop up position of the closure panel and an unlatched position of the latch.

### CROSS-REFERENCE TO RELATED APPLICATION

This application claims the benefit of U.S. Provisional Application Ser. No. 63/482,665, filed Feb. 1, 2023, which is incorporated herein by reference in its entirety.

### FIELD

This disclosure relates to operational mechanisms for a closure panel.

### BACKGROUND

Some vehicles are equipped with a closure panel, such as a lift gate, which is driven between an open position (position 2) and a closed position (position 1) using an electrically driven lift or opening system, as well as a operated latch. Disadvantages of the current systems include pop up noise occurring when the latch is first operated from the fully closed position to the release or open position.

Typically you need a hood/mechanical spring to pop-up a heavy hood to a position where you can move the hood to an open position. Now with powered Frunk (Front-Trunk) systems, there are new powered features required for a user to regularly access the space where the engine normally goes, including a powered drive unit to move the hood upwards and a cinch mechanism to close the hood without slamming against increased seal loads (since a frunk can store personal items, it requires better sealing compared to when an engine occupies the space).

However a pop-up spring, normally used in a hood system to move the hood up to a pop-up position after a latch release, must be compressed by the cinch motor which therefore requires more power and a larger motor. The use of a pop-up spring therefore adds costs to the system set up and operation of the frunk. Also, when using a pop-up spring when a user is regularly accessing the frunk, the closure of the hood against the pop up spring produces an undesirable clunk sound and an unsightly uncontrolled upwards movement of the hood.

Further, the use of the mechanical spring relies upon gravity as an energy input to the closing motion of the hood, which inhibits system control of the hood lid for obstacle detection. Further, desirable smooth motion control when the motion transitions from pop up spring to frunk system drive can be restricted by kinematic conditions.

### SUMMARY

It is an object of the present invention to provide a frunk operational system that obviates or mitigates at least one of the above presented disadvantages.

One aspect provided is a closure panel movement system for moving a closure panel of a frunk of a vehicle between a fully closed position and a fully open position, the system comprising: a latch mounted to a body of the vehicle, the latch for maintaining the closure panel in the fully closed position; a presentment mechanism positioned between the closure panel and the body; and a drive unit coupled to the closure panel for driving the closure panel when unlatched to and from the fully open position; wherein the presentment mechanism assists in movement of the closure panel between a pop up position of the closure panel and an unlatched position of the latch.

A further aspect provided is a method of operating a closure panel movement system for moving a closure panel of a frunk of a vehicle between a fully closed position and a fully open position, the method comprising: operating a latch mounted to a body of the vehicle, the latch for maintaining the closure panel in the fully closed position; operating a presentment mechanism positioned between the closure panel and the body to move the closure panel with respect to a pop up position of the closure panel; and operating a drive unit coupled to the closure panel to drive the closure panel when unlatched to and from the fully open position; wherein the presentment mechanism assists in movement of the closure panel between the pop up position of the closure panel and an unlatched position of the latch.

A further aspect includes a closure panel movement system for moving a closure panel of a vehicle between a fully closed position and a cinch start position and a pop-up position and a fully open position, the system having a first powered actuator adapted to control movement of the closure panel from the cinch start position to the fully closed position, and a second powered actuator adapted to control the movement of the closure panel from the pop-up position to the cinch start position, where the presentment mechanism assists in movement of the closure panel between the pop up position of the closure panel and an unlatched position of the latch. The closure panel movement system may further include a third actuator adapted to move the closure panel between the pop-up position and the fully open position. A pop-up spring may be adapted so as not to resist the motion of the closure panel during the control of the first powered actuator and the second powered actuator.

Other aspects, including methods of operation, and other embodiments of the above aspects will be evident based on the following description and drawings.

### BRIEF DESCRIPTION OF THE DRAWINGS

Reference is made, by way of example only, to the attached figures, wherein:

FIG. 1 is a side view of a vehicle with one or more closure panels;

FIG. 2 is a front view of a vehicle with one or more closure panels illustrating a latching mechanism operated as a hinge and a latch;

FIG. 3 is a side view of an alternative embodiment of the vehicle of FIG. 1;

FIG. 4 is an example latch configuration of the vehicle of FIGS. 1,2,3;

FIG. 5 is diagram of a control system the hood movement system of FIG. 3;

FIGS. 6a,b,c show an example open operation of the hood movement system of FIG. 5;

FIG. 7 is an example timing diagram of the operation of FIGS. 6a,b,c;

FIGS. 8a,b,c show an example close operation of the hood movement system of FIG. 5;

FIG. 9 is an example timing diagram of the operation of FIGS. 8a,b,c;

FIGS. 10a,b,c show a further example open operation of the hood movement system of FIG. 5;

FIGS. 11a,b are example mechanical and control layouts of the hood system of FIG. 1;

FIGS. 12a,b,c,d show a further example close operation of the hood movement system of FIG. 5;

FIGS. 13a,b show example presentment mechanisms of the system of FIG. 5.

FIG. 14 shows an example grab feature of the vehicles of FIGS. 1,2,3; and

FIG. 15 is an example operation of the hood movement system of FIGS. 1 to 14.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

In the following description, details are set forth to provide an understanding of the disclosure. In some instances, certain software, circuits, structures, techniques and methods have not been described or shown in detail in order not to obscure the disclosure. The term “controller” is used herein to refer to any machine for processing data, including the data processing systems, computer systems, modules, electronic control units (“ECUs”), microprocessors or the like for providing control of the systems described herein, which may include hardware components and/or software components for performing the processing to provide the control of the systems described herein. A computing device is another term used herein to refer to any machine for processing data including microprocessors or the like for providing control of the systems described herein. The present disclosure may be implemented in any computer programming language (e.g. control logic) provided that the operating system of the control unit provides the facilities that may support the requirements of the present disclosure. Any limitations presented would be a result of a particular type of operating system or computer programming language and would not be a limitation of the present disclosure. The present disclosure may also be implemented in hardware or in a combination of hardware and software.

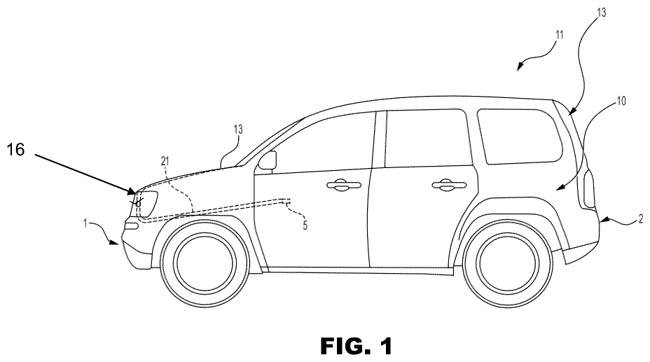

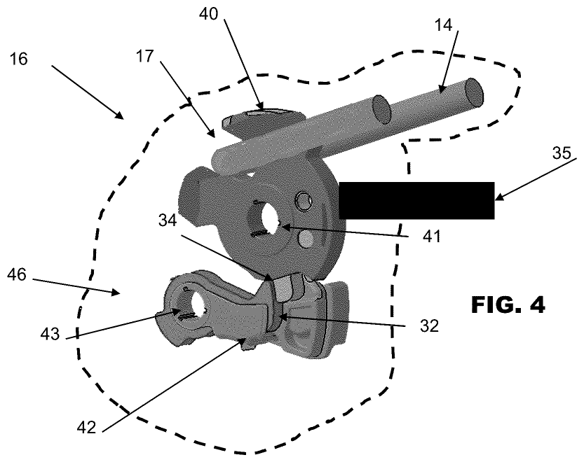

Referring to FIGS. 1, 2 and 3, provided is a hood system 9 (e.g. a closure panel movement system) for a closure panel 13 operating as a Frunk. In one embodiment, as shown, the hinges 12a,b are mounted to a body 10 of a vehicle 11, while a latch 16 of the latching system is mounted on the body 10 and a mating latch component 14 (see FIG. 4) is mounted on the closure panel 13 (e.g. a hood). In an alternative embodiment, the latch 16 can be mounted to the closure panel 13 of the vehicle 11, while the mating latch component 14 can be mounted on the body 10. The hood system 9 is provided as a powered system to introduce electrically controlled motion of the hood 13 between a fully closed position 13a and a fully open position 13b.

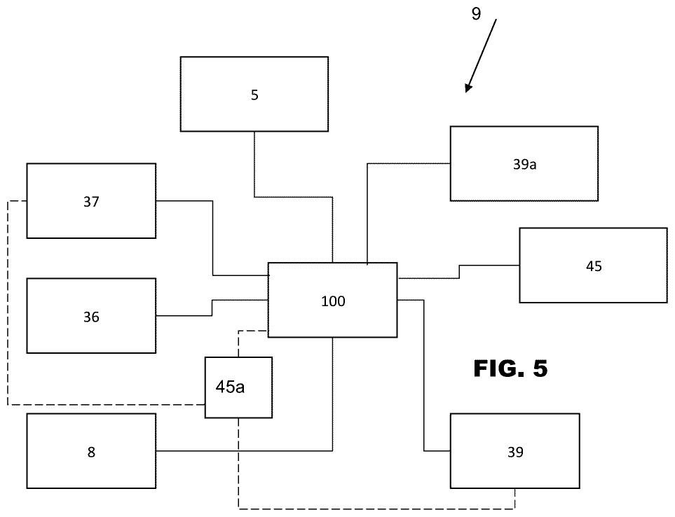

The vehicle 11 can have one or more controls (e.g. button, switch, proximity sensor of a mechanical handle, etc.) 5 for controlling the operation of the latch 16 (e.g. an e-latch, a release lever, etc.) of the hood system 9, as well as a drive unit 8 and presentment mechanism 15 (e.g. powered by a presenter motor 39—see FIG. 5), as further described below. The control(s) 5 can be connected to the latch 16 of the hood system 9 by a respective connection 21 (e.g. Bowden Cable, electrical signal cable, and/or wireless connection—for example in relation to an appropriately configured wireless transmitter such as a FOB). In addition, the vehicle 11 has a front end 1 and a back end 2. Further, the controls 5 can be used instruct a controller 100 to synchronize the operation of the latch 16, presenter mechanism 15 and drive unit 8, as further described below. Further, the vehicle 11 can have one or more detection sensors (e.g. pinch, obstacle—see FIG. 5) 39a mounted on the vehicle body 10, latch 16, and/or closure panel 13, for providing respective detection signals to the controller 100. One example of a presenter mechanism 15 is shown and described in US Patent Publication No. US20210301561A1, titled “Door system with door presenter control”, which is incorporated herein by reference in its entirety. Another example of a presenter mechanism 15 is shown and described in US Patent Publication No. US20230220713A1, titled “Driven spring system for hood”, which is also incorporated herein by reference in its entirety. One example of a drive unit 8 for a hood is shown and described in US Patent Publication No. US20230356688A1, titled “Actuation system for a closure panel including a pop up safety system for hinges”, which is incorporated herein by reference in its entirety.

The controls 5 (e.g. user interface) could be connected to the controller 100 of the vehicle 11 to operate the latch 16, see FIG. 5. For example, when the controller 100 receives an open signal command from a wireless FOB key, this indicates to the controller 100 a user's intent to have the closure panel 13 opened. For example, when the controller 100 receives a close signal command from a wireless FOB key, this indicates to the controller 100 a user's intent to have the closure panel 13 closed.

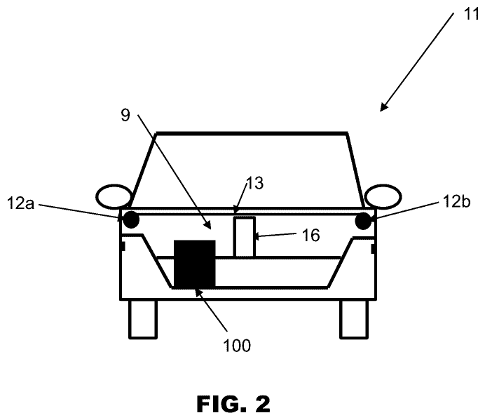

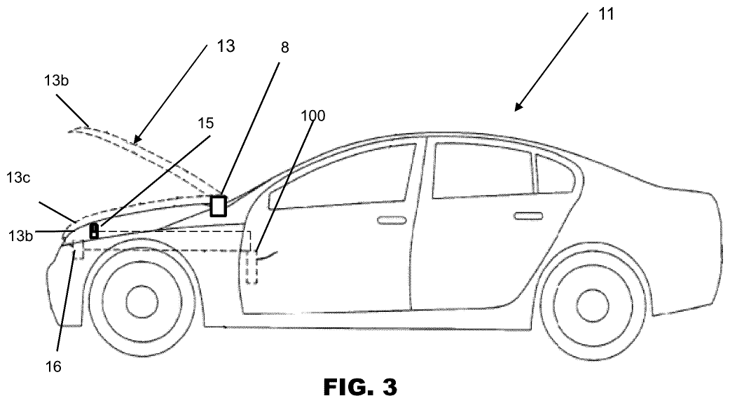

As shown in FIG. 2, the closure panel 13 can be used to cover an internal (e.g. storage) space of the vehicle 11. As further described below, operation of the closure panel 13 between an open position (see FIG. 3), a presented position and a closed position (see FIG. 1) can be assisted by the latch 16 and the presenter mechanism 15 of the hood system 9. It is also recognised that opening and closing of the closure panel 13 can be performed manually by a user of the vehicle 11, once the latch 16 has been released. It is recognised that in the closed position the latch 16 can provide that the corresponding striker 14 and associated ratchet 40 to lock the closure panel 13 in the closed position (for example see FIG. 4).

Referring again to FIGS. 1 and 2, shown is the vehicle 11 with the vehicle body 10 having one or more closure panels 13. For vehicles 11, the closure panel 13 can be referred to as a partition or door, typically operated in a hinged fashion, but sometimes attached by other mechanisms such as tracks, in front of an opening which is used for entering and exiting the vehicle 11 interior by people and/or cargo (e.g. luggage). It is also recognized that in some applications, the closure panel 13 could be used as an access panel for vehicle 11 systems such as engine compartments and also for traditional trunk compartments of automotive type vehicles 11.

The closure panel 13 can be opened to provide access to a space, or closed to secure or otherwise restrict access to the space. For example decklids, frunks (e.g. front trunk), hoods, tailgates can be referred to as the closure panel 13. Also closure panel 13 can be for a center console with hinged lid configuration, glove compartments, pickup truck covers, windows and the like. It is also recognized that there can be one or more intermediate hold positions (e.g. presented position 13c—see FIG. 3) of the closure panel 13 between a fully open position and fully closed position, as provided at least in part by the drive unit 8. For example, the actuator can assist in biasing movement of the closure panel 13 away from one or more intermediate hold position(s), also known as Third Position Hold(s) (TPHs) or Stop-N-Hold(s), once positioned therein, as the actuator acts on the closure panel 13. It is also recognized that the actuator (e.g. linear actuator) can be provided as a component of a closure panel 13 assembly, as desired.

In view of the above, the closure panel 13 can be opened manually and/or powered electronically via the drive unit 8, where powered closure panels 13 can be found on minivans, high-end cars, or sport utility vehicles (SUVs) and the like. Additionally, one characteristic of the closure panel 13 is that due to the weight of materials used in manufacture of the closure panel 13, some form of force assisted open and close mechanism (or mechanisms), such as the drive unit 8 and/or presenter 15, is/are used to facilitate operation of the open and close operation by an operator (e.g. vehicle driver) of the closure panel 13. The force assisted open and close mechanism(s) can be provided by torsion element(s), a motor, and/or any biasing members external to the actuation mechanism (e.g. spring loaded hinges, spring loaded struts, gas loaded struts, electromechanical struts, etc.), as desired, when used as part of the closure panel 13 assembly.

Referring to FIG. 4, shown is an example latch 16 including a ratchet 40 and a pawl 42, such that the pawl 42 retains the ratchet 40 in a latched position (i.e. holding the mating latch component 14 within a slot 17 of the ratchet 40). In this figure, the pawl 42 is shown in a closed position, such that a pawl surface 32 is in contact with a ratchet surface 34, thus maintaining the ratchet in the closed/locked position while these surfaces 32, 34 are in contact. The ratchet 40 pivots about a ratchet pivot axis 41 and the pawl 42 pivots about a pawl pivot axis 43, for example, as the latch 16 is operated between the latched position (shown) and an unlatched position (i.e. when the mating latch component 14 is allowed to exit the slot 17. The ratchet 40 and the pawl 42 are mounted to a latch frame 46, such that the ratchet 40 can be biased towards the open position by a ratchet biasing element (not shown). Further, the pawl 42 can be biased towards contact with the ratchet 40 via a pawl biasing element (not shown). It is recognized that the latch 16 is mounted to the closure panel 13 or the vehicle body 10 by the latch frame 46 (e.g. as part of a body/housing of the latch 16). For example, it is recognized that movement of the pawl 42 about the pawl pivot 43 (e.g. by operation of the connection 21—see FIG. 1—such as by example via a vehicle controller module 100 as is known in the art) causes the pawl 42 to disengage from the ratchet 40 and thus facilitate the ratchet 40 to pivot about the ratchet pivot 41 and thus allow the mating latch component 14 to exit the slot 17. Similarly, restricting movement of the pawl 42 about the pawl pivot 43 (e.g. by a pawl biasing element such as a torsion spring as is known in the art) causes the pawl 42 to maintain engagement with the ratchet 40 and thus inhibit the ratchet 40 to pivot about the ratchet pivot 41 and thus retain the position of the mating latch component 14 within the slot 17. A cinch arm 35, e.g. operated by a cinch motor 36 (see FIG. 5) can be used to cinch the latch 16 into the fully closed position, by acting against any bias/resistance of the closure seals (not shown) of the closure panel 13. For example, the cinch arm 35 can be actuated by the cinch motor 36 to move the ratchet 40 from a partially open position to the fully closed position. Motors 36,37 may be the same, depending on latch 16 configuration. Cinch motor 36, as an example of a first powered actuator, illustratively controls the powered (electrical) motion of the closure panel 13 from a cinch start position (which may be for example the secondary locking position of the latch 16). One example of a latch 16 having a cinching configuration is shown and described in US Patent Publication No. US20200318400A1, titled “Power actuator having cam-driven dual cable actuation mechanism for use with vehicular closure latch assembly”, which is incorporated herein by reference in its entirety.

It is also recognized that the latch 16 can also be configured as an elatch as is known in the art including a power release motor 37 mounted on the frame 46, which in this case the cinch motor 36 could also be incorporated on the latch frame 46.

The configuration of the latch 16 components of FIG. 4 corresponds to the latch 16 state shown in FIG. 1, as the closure panel 13 is in the closed position. For ease of explanatory purposes only, the closure panel 13 and the body 10 of the vehicle 11 are not shown in FIG. 4. FIG. 5 also shows power 45 for powering the various actuation units (e.g. motors 36, 37, 39), as well as back up power 45a, as desired. In particular, it is recognized that operation of the presenter 15 as part of the hood system 9 provides for a controlled opening of the hood to pop-up (e.g. from the fully closed position to the partially open/presented position).

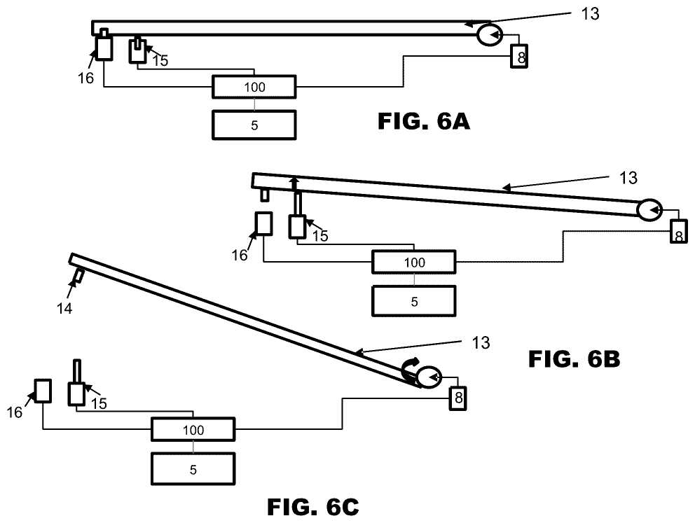

Referring to FIG. 6a, b, c, shown is an example operational embodiment of the hood system 9 for an opening operation of the closure panel 13, which does not utilize a biasing element (external to the latch 16) for assisting in movement of the hood 13 between the fully closed position and the fully open position. FIG. 6a shows the hood 13 in a full closed position, the latch 16 fully closed and the presenter 15 retracted.

FIG. 6b shows the hood 13 moving upwards by the presenter 15, the latch 13 with a Power Release ON (using the motor 37 to open the latch 16) and the presenter 15 extending (using the motor 39). Controller 100 receives control command from the user interface 5 (e.g. button/FOB/BCM etc). Latch 16 is powered released and next the presenter 15 is powered to move hood 13 to the pop-up/presented position. When the latch 16 is released, the seal load (e.g. no pop-up hood spring) may be insufficient to move hood 13 upwards. Thus the presenter 15 will move hood 13 upwards against gravity acting on hood 13 and will back drive the hood drive unit 8. Alternatively, the drive unit 8 may be driven at the same time as the presenter motor 39 to avoid the back drive friction.

FIG. 6c shows the hood 13 moving upwards by drive unit 8, the latch 16 with the Power Release OFF, the presenter 15 remaining in the presented position (or the presenter 15 may be retracted). The controller powers the hood 13 to the full open position using the hood drive unit 8 at position with improved moment arm compared to the fully closed position. The presenter 15 may be maintained in extending position (by the motor 39) in case of drive unit 8 failure as a backstop against pinch events. Alternatively, the presenter 15 may be retracted to a fully retracted position.

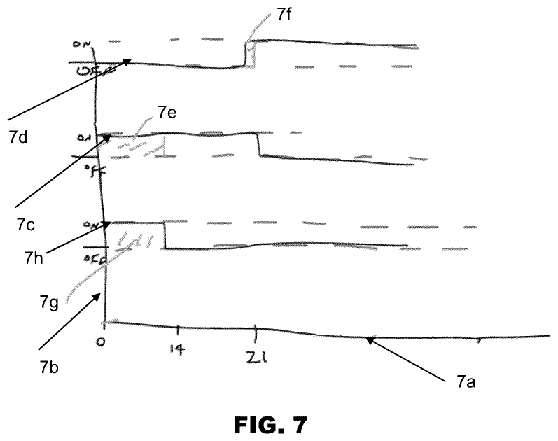

FIG. 7 shows an illustrative hood opening timing diagram for the seal load, actuators (e.g. 36, 37, 39) and the spindle (not shown) of the drive unit 8.

For example, shown is seal load 7a verses gate (e.g. also referred to as frunk indicated by reference numeral 13) distance to close 7b (in mm, both for the actuator portion 7c and the spindle portion 7d). Further, in terms of the actuator portion 7c, the actuator will catch up to the frunk in region 7e due to the seal load. In terms of the spindle portion 7d, this will start in region 7f before pop out of the frunk in order to maintain constant velocity (or it can stop the frunk at pop up.). It is also recognised that in region 7g, the bounds of this region 7g can be configured based on gate mass/seal load (e.g. can be calibrated over time via the sensors/switches as provided in the system 9). Cinch portion 7h shows the cinch timing operation.

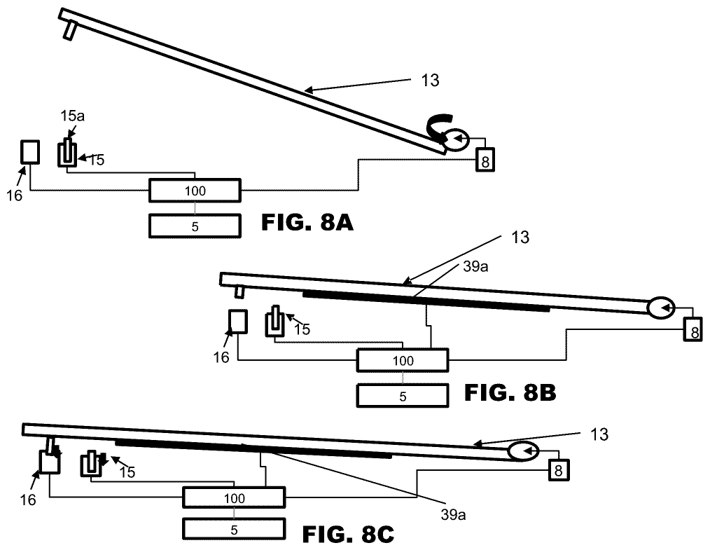

FIGS. 8a,b,c show an example operational embodiment of the hood system 9 for an closing operation of the closure panel 13, which does not utilize a biasing element (external to the latch 16) for assisting in movement of the hood 13 between the fully closed position and the fully open position. FIG. 8a shows the hood 13 moving downwards by the drive unit 8 with the latch having cinch motor 36 OFF and the presenter 15 in the retracted position. The controller 100 receives a command from UI 5 to power close the hood 13 and controls drive unit 8 in the closing direction. The hood 13 will be driven/braked against gravity until it reaches the secondary position (e.g. partially open/presentment position).

FIG. 8b shows the hood 13 moving downwards by the drive unit 8 with the latch 16 having the cinch motor 36 OFF and the presenter 15 has its plunger 15a retracted by the motor 39. Due to kinematics, the drive unit 8 can be configured for braking the hood 13 motion against gravity during closing. Depending on the seal load, the drive unit 8 can be driven to over come increasing seal load towards the secondary position.

FIG. 8c shows the hood 13 moved to the secondary by drive unit 8 with the latch 16 powered by the cinch motor 36 ON and the presenter 15 with the plunger 15 retracted by the presenter motor 39. At secondary position of the hood 13, the cinch latch 13 (e.g. using the cinch motor 36 to operate the cinch arm 35) is powered to cinch the hood 13 to primary closed position and thus close the latch 16. The plunger 15 is already retracted so as not to act against the cinching of the hood 13. For example, the plunger 15 can be moved out of contact with the hood 13. Advantageously, as no pop-up spring is provided, the cinch motor 36 only has to overcome the seal load, with gravity assisting. The cinch motor 36 does not have to overcome a pop-up hood spring (absent as shown, which in state of the art systems would be positioned between the body 10 and the underside of the hood 13) as the presenter 15 can provide the pop-up function (moving the hood 13 from the fully closed to the partially open/presentment position—see FIG. 3). Alternatively, the hood 13 may be moved over a first range of travel from an open position towards the pop-up position 13 f by drive unit 8 as a third electrically powered actuator, whereat presenter 16, as an example of a second actuator, there after controls movement of the hood 13 from the pop-up position over a second range of travel towards the cinch start position, or the secondary catch position of latch 16, whereat there after the latch 16 powered by the cinch motor 36, or the first actuator, moves the hood 13 to the fully closed position from the cinch start position over a second range of travel. Presenter 16, as an example of the second electrically powered actuator, illustratively controls the powered motion of the closure panel 13 from the pop up position to cinch start position (which may be for example the secondary locking position of the latch 16). The motion of the hood 13 thus in one possible configuration can be controlled different ranges of motion using a powered actuator. Use of gravity or a user manually moving the hood 13 in such a possible configuration is not required. Furthermore, during such stages of motion of the hood 13, the compression of a pop-up spring may optionally not be required or occur. Compression of a pop-up spring may occur after the end of the third range of travel when the latch 16 is in primary latch position, for example by moving the pop-up spring up against the hood 13 using the presenter 16 in one possible configuration. In such a configuration, the powered motion control by the first, second and/or third actuators does not have to act to compress the pop-up spring during its motion towards the fully closed/latched position; resistance to the motion of the closure panel due to the pop-up spring can be reduced and/or eliminated. One possible benefit includes the reduction of pinching forces and actuator power output can be lowered during the motion of the hood 13. Disablement of the pop-up spring compression during closing motion of the hood 13 may also possibly improve the use and/or sensitivity of pinch detection algorithms detecting the motion of the hood 13. One example of a pinch detection algorithm is shown and described in US Patent Application Publication No. US20220243503A1 titled “Anti-pinch protection system utilizing latch control”, the contents of which is incorporated herein by reference in its entirety.

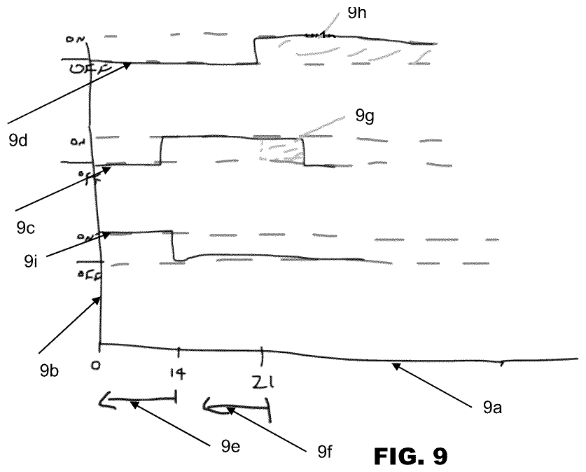

FIG. 9 shows an illustrative hood closing timing diagram for the seal load, actuators (e.g. 36, 37, 39) and the spindle (not shown) of the drive unit 8.

For example, shown is seal load 9a verses gate distance to close 9b (in mm, both for the actuator portion 9c and the spindle portion 9d). Further, cinch travel 9e and popup travel 9f are shown. In terms of the actuator portion 9c, the actuator will rise to meet the frunk in region 9g. In terms of the spindle portion 9d, this will lower the frunk in region 9h. It is also recognised that depending upon the gate mass verses seal load the cinch distance/travel 9e can be reduced. Cinch portion 9i shows the cinch timing operation.

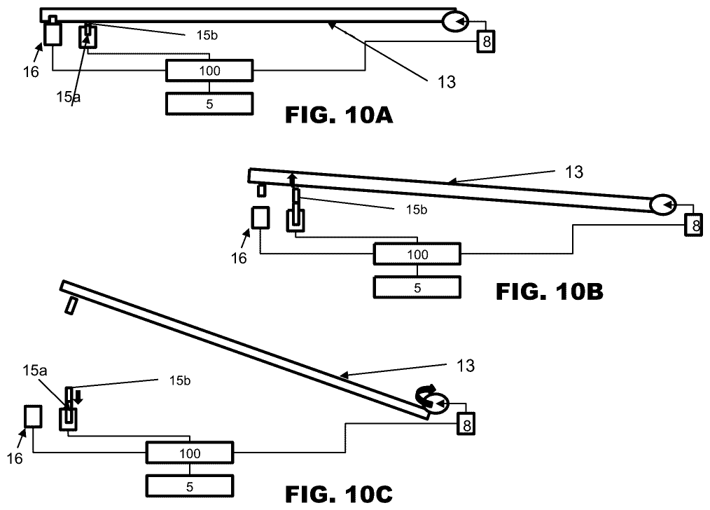

FIGS. 10a,b,c show an alternative embodiment of the hood system 9 for opening of the hood 13, with a hood biasing element 15b (e.g. spring) positioned on an end of extendable/retractable plunger 15a. FIG. 10a shows the hood 13 in the fully closed position with the latch 16 fully closed and the presenter 15 partially extended to compress spring 15b against the underside of the hood 13.

FIG. 10b shows the hood 13 moving upwards by the spring 15b coupled to presenter 15 (e.g. end of the plunger 15a) with the latch 16 operated using the latch motor 37 with power release ON and the presenter 15 having the stationary, spring 15b uncompressed. The controller 100 receives a control command from the user interface 5. The latch 16 is power released (e.g. pawl 42 is operated to release the ratchet 40). When the latch 16 is released, spring 15b moves the hood 13 upwards to the pop-up position with the presenter 15 not moving (e.g. plunger 15a stays retracted). Optionally, the presenter 15 can be operated if required to overcome heavy loads e.g. due to hood 13 weight.

FIG. 10c shows the hood 13 moving upwards by the drive unit 8 with the latch 16 in the power release OFF state and the presenter 15 retracting using the presenter motor 39. The controller 100 is powered to operate the hood 13 to the fully open position using the hood drive unit 8 at position with improved moment arm compared to the fully closed position. Optionally, the presenter 15 is maintained in the extending position in case of drive unit 8 failure as a back stop against pinch events. Or, the presenter 15 can be moved to the partially extended position, as desired.

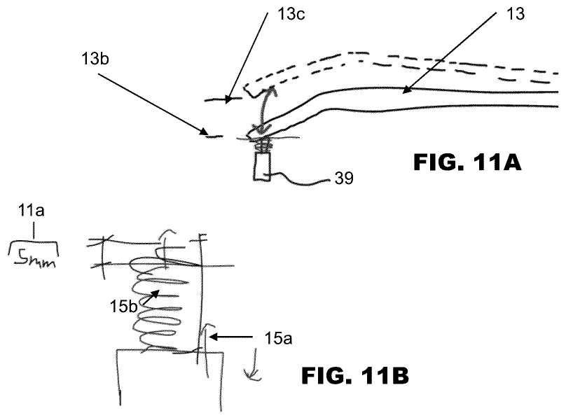

FIGS. 11a,b show an example mechanical and control layout of the hood system 9 including the plunger 15a and biasing element 15b, in the fully closed position 13b and the pop-up/presentment position 13c including retraction and extension of the spring 15b as appropriate. For example, shown is a no power preload adjustment 11a example (e.g. 5 mm) for power as configured (e.g. example spring constant of 30 for 150 N of element 15b). Further, the actuator (e.g. presentment motor 39) can be used to lift/lower the frunk 13 from pop up interaction. As such, FIGS. 11a,b show an example configuration whereby a feature can be added on the grill of the vehicle 11 to grab by the vehicle user for gate (e.g. also referred to as frunk indicated by reference numeral 13) travel defined by the pop up travel distance facilitated by the seal load. Also, the pop up spring 15b is included, such that the pop up spring 15b can be compressed by the presentment motor 39.

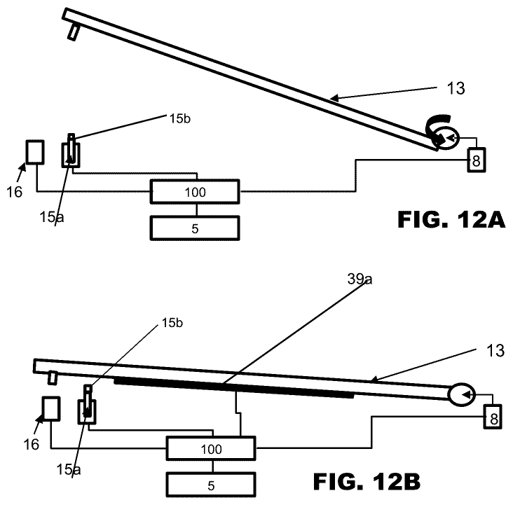

FIGS. 12a,b,c,d show an alternative embodiment of the hood system 9 for closing of the hood 13, with a hood biasing element 15b (e.g. spring) positioned on an end of extendable/retractable plunger 15a. FIG. 12a shows the hood 13 moving downwards by the drive unit 8 with the latch 16 having the cinch motor 36 OFF, the presenter 15 partially extended with the spring 15b uncompressed. The controller 100 receives 1 command from the UI 5 to power close the hood 13 and controls the drive unit 8 in the closing direction. The hood can be driven until it reaches the secondary latched position. The drive unit 8 can control the motion of the hood 13 until the secondary latched position/e.g. presentment position.

FIG. 12b shows the hood 13 moving downwards by the presenter 15 with the latch 13 having the cinch motor 36 OFF and the presenter 15 with the plunger 15a being retracted.

FIG. 12,c shows the hood 13 moving downwards by the cinch motor 36 with the latch 13 cinch motor 36 ON and having the presenter plunger 15a retracted but not having the spring 15b contacting the underside of the hood 13. At the secondary position of hood 13, the cinch latch 13 is powered to cinch (using motor 36) the hood 13 to the primary closed position. The plunger 15 is continued to be retracted so as not to act against the cinching of the hood 13, e.g. the spring 15b (e.g. in uncompressed state) on the plunger 15a is moved out of contact with the underside of the hood 13.

FIG. 12d shows the hood 13 in the primary closed position with the latch cinch motor 36 OFF and the presenter plunger 15a extended to compress the spring 15b against the underside of the hood 13. As such, the presenter 15 can be used to load the biasing element 15b when the hood 13 is in the fully closed position, however the biasing element 15b is only put in the biased state after the latch 16 has been cinched, so that the biasing element 15b does not act against the operation of the cinch motor 36. At the primary latched position, the cinch motor 36 is turned OFF. The presenter 15 is extended to now compress the spring 15b against the underside of the hood 13. In case of subsequent power loss, the compressed spring 15b will provide energy to move the hood 13 to the pop-up position in case of subsequent latch 13 release.

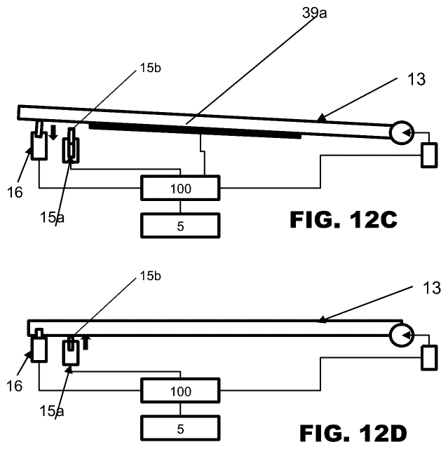

FIGS. 13a,b show two different options for the hood 13 in the secondary position 13e (after release of the latch 16) and subsequently in the pop up position 13f under influence of the presenter plunger 15a, such that “L” represents presenter plunger 15a travel. FIG. 13b shows the hood 13 in the secondary position 13e (after release of the latch 16) and subsequently in the pop up position 13f under influence of the presenter biasing element 15b, such that “L” represents presenter plunger spring 15b travel (or decompression). FIG. 13a shows the actuator 39 in operation of pushing the frunk 13 to the pop up position 13f. Alternatively, FIG. 13b shows the actuator 39 in operation of compressing spring 15b in order to move the frunk 13 to the pop up position 13f.

It is recognized that the operation of the hood 13 with the hood system 9 can be powered using backup power 45a to open the hood 13. In this manner, the presentment motor 39 and the latch motor 37 can be operated by the back up power 45a following FIGS. 6a,b,c, 8a,b,c and FIGS. 10a,b,c, 12a,b,c,d, as desired, as well as FIGS. 13a,b.

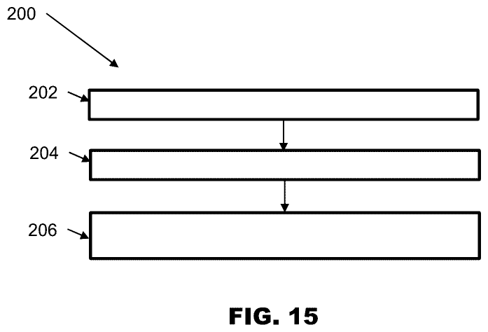

Referring to FIG. 15, a method 200 for operating the movement system 9 for facilitating opening and closing of a closure panel 13 of a vehicle 11, the method 200 comprising the steps of: operating 202 the latch 16 mounted to the body 10 of the vehicle 11; operating 204 the presentment mechanism 15 positioned between the closure panel 13 and the body 10 to move the closure panel 13 with respect to a pop up position of the closure panel 13; and operating 206 a drive unit 8 coupled to the closure panel 13 to drive the closure panel 13 when unlatched to and from the fully open position; wherein the presentment mechanism 15 assists in movement of the closure panel 13 between the pop up position of the closure panel 13 and an unlatched position of the latch 16.

In view of the above, the hood system 9 can employ a presenter mechanism 15, used in situations such as but not limited to: 1) the presenter mechanism 15 is utilized to physically lift the hood 13 into the pop up position and 2) the presenter mechanism 15 would push on a biasing element 15b to preload the hood 13 when in the fully closed position. The biasing element 15b can be connected to the plunger 15a. When deployed, the combined force output of the spring 15b and the actuator (e.g. presentment motor 39) would result in motion of the hood 13 between the fully closed position and the pop up position. It is recognized that the initial movement of the hood can be caused by release of the latch 16 from its fully closed/latched position. Once unlatched (or in the process of unlatching once the pawl 42/ratchet 40 is/are released), then the presenter plunger 15a (with or without the optional biasing element 15b) can be used to move the hood 13 into the secondary/pop up position. For example, the secondary position can be between the pop up position and the fully closed position.

For example, in the second option, the presentment motor 39 would retract the plunger 15a and thus inhibit compression of the biasing element 15b during movement of the hood 13 under influence of the cinch motor 36. Further, the presence of the biasing element 15b can provide for some backup method when power is lost to the presentment motor 39.

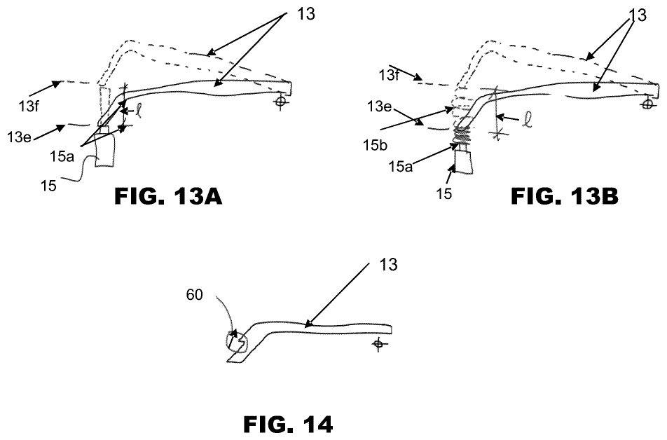

As such, given the above, when the traditional pop up spring (positioned between the body 10 and the hood 13) is not utilized in the hood system 9 as configured above, the ability to open the hood 13 in the event of a loss of power can be hindered. In this case, an integrated grab feature 60 (see FIG. 14), such as an indent of other graspable element positioned on/within the hood 13. For example, the grab feature 60 can be integrated with styling considerations othe vehicle (e.g. in the grill as discussed herein). The utility of the grab feature 60 can be to inhibit the vehicle user from grabbing the frunk 13 in a travel position wherein a pinch issue is possible. For example, the grab feature 60 can be positioned away from the interface between the hood 13 and the body 10 (where the seals are located). In event of no power/or spring, the grab handle 60 on the hood 13 can be provided to facilitate the user to move the hood 13 after power release (of the latch 16) if hood 13 has not moved away from primary latch position (e.g. latch 16 is in the latched/closed position).

Further, the presenter 15 of the hood system 9 can be used to raise the hood 13 in the absence of a traditional pop up spring. As the presenter 15 is electrically controlled, the use of the presenter 15 can provide for inhibiting generation of pop up noise encountered with traditional pop up spring use and provide for more control in movement (e.g. smoother) transition to the drive unit 8. Similarly, the presenter 15 can be used to lower the hood 13 in a electronically controlled fashion from the pop up/secondary position down to when the cinch operation starts. Preferably, the seal load acts on the hood 13 after engagement of the hood 13 (via the latch 16) to the secondary position.

We claim:

1. A closure panel movement system (9) for moving a closure panel (13) of a frunk of a vehicle (11) between a fully closed position and a fully open position, the system comprising:
a latch (16) mounted to a body(10) of the vehicle, the latch for maintaining the closure panel in the fully closed position;
a presentment mechanism (15) positioned between the closure panel and the body; and
a drive unit (8) coupled to the closure panel for driving the closure panel when unlatched to and from the fully open position;
wherein the presentment mechanism assists in movement of the closure panel between a pop up position of the closure panel and an unlatched position of the latch.

2. The movement system of claim 1; wherein the unlatched position is a secondary latch position of the latch.

3. The movement system of claim 1 further comprising the presentment mechanism having a biasing element (15b) positioned adjacent to the closure panel when the closure panel is in the pop up position.

4. The movement system of claim 3; wherein the biasing element is positioned on a plunger (15a) of the presentment mechanism.

5. The movement system of claim 1; wherein the latch includes a cinch motor (36) for providing a cinch operation of the latch.

6. The movement system of claim 1 further comprising a controller (100) for electronically controlling the movement of the closure panel using the presentment mechanism and the drive unit between the unlatched position and the fully open position.

7. The movement system of claim 5; wherein the biasing element is in an unbiased state when a cinch motor operates the latch to the fully closed position.

8. The movement system of claim 3; wherein the biasing element is the only spring biasing the closure panel in a direction away from the fully closed position.

9. The movement system of claim 8 further comprising a grab feature (60) located on the closure panel, the grab feature to facilitate by a vehicle user the movement of the closure panel towards the pop up position due to operation failure of the presentment mechanism.

10. The movement system of claim 1, wherein the latch 16 is an including at least one of a power release motor (37) and a cinch motor (36).

11. A method of operating a closure panel movement system (9) for moving a closure panel (13) of a frunk of a vehicle (11) between a fully closed position and a fully open position, the method comprising:
operating a latch (16) mounted to a body(10) of the vehicle between a latched and an unlatched position, the latch for maintaining the closure panel in the fully closed position;
operating a presentment mechanism (15) positioned between the closure panel and the body to move the closure panel with respect to a pop up position of the closure panel; and
operating a drive unit (8) coupled to the closure panel to drive the closure panel when unlatched to and from the fully open position;
wherein the presentment mechanism assists in movement of the closure panel between the pop up position of the closure panel and an unlatched position of the latch.

12. The method of claim 11; wherein the unlatched position is a secondary latch position of the latch for the frunk.

13. The method of claim 11 further comprising the presentment mechanism using a biasing element (15b) positioned adjacent to the closure panel when the closure panel is in the pop up position.

14. The method of claim 13; wherein the biasing element is positioned on a plunger (15a) of the presentment mechanism.

15. The method of claim 11 further comprising performing a cinch operation of the latch by a cinch motor (36) of the latch.

16. The method of claim 11 further comprising electronically controlling the movement of the closure panel using the presentment mechanism and the drive unit between the unlatched position and the fully open position.

17. The method of claim 15 further comprising cinching the latch to the fully closed position when the biasing element is in an unbiased state.

18. A closure panel movement system (9) for moving a closure panel (13) of a vehicle (11) between a fully closed position and a cinch start position and a pop-up position and a fully open position, the system comprising:
a first powered actuator adapted to control movement of the closure panel from the cinch start position to the fully closed position; and
a second powered actuator adapted to control the movement of the closure panel from the pop-up position to the cinch start position
wherein the presentment mechanism assists in movement of the closure panel between a pop up position of the closure panel and an unlatched position of the latch.

19. The closure panel movement system of claim 18, further comprises a third powered actuator adapted to move the closure panel between the pop-up position and the fully open position.

20. The closure panel movement system of claim 18, wherein a pop-up spring does not resist the motion of the closure panel during the control of the first powered actuator and the second powered actuator.
